(19) United States
(12) Patent Application Publication
(10) Pub. No.: US 2024/0073157 A1
(43) Pub. Date: Feb. 29, 2024

(54) DEVICE, METHOD AND PROGRAM FOR COMMUNICATION PROCESSING

(71) Applicant: NIPPON TELEGRAPH AND TELEPHONE CORPORATION, Tokyo (JP)

(72) Inventors: Hiroya ONO, Musashino-shi, Tokyo (JP); Satoshi NARIKAWA, Musashino-shi, Tokyo (JP); Takuya ABE, Musashino-shi, Tokyo (JP); Yuki SAKAUE, Musashino-shi, Tokyo (JP); Tomohiko IKEDA, Musashino-shi, Tokyo (JP)

(73) Assignee: NIPPON TELEGRAPH AND TELEPHONE CORPORATION, Tokyo (JP)

(21) Appl. No.: 18/270,412

(22) PCT Filed: Jan. 4, 2021
(86) PCT No.: PCT/JP2021/000023

§ 371 Date: Jun. 29, 2023

(51) Int. Cl. H04L 47/80; H04L 41/5003; H04L 41/5067

(52) U.S. Cl. CPC H04L 47/805; H04L 41/5003; H04L 41/5067

(57) ABSTRACT

An object of the present disclosure is to enable network control to be executable that does not deteriorate experience quality of a user even in a case where the user uses a terminal.

A communication processing device according to the present disclosure,
when detecting occurrence of network control that is different from a user controlled application, collects user information indicating a state of a user that uses a terminal, predicts an experience quality change of the user in a case of executing the network control using the user information obtained by the collection, and executes the network control on the basis of an experience quality change amount of the user obtained by the prediction.

### TECHNICAL FIELD

The present invention relates to suppression of degradation of user experience quality by network control of a communication terminal.

### BACKGROUND ART

In an existing communication terminal, while an application is used by a user, network control such as handover and update of in-terminal software for enabling the application is performed according to a situation. Since this network control consumes calculation resources and communication resources of the terminal, there is a case where the network control affects the quality of the application, and experience quality of the user may deteriorate.

Also in the related art, there is a technology of predicting communication to be performed by a terminal in the future by using communication time, the number of transmission control protocol (TCP) connections, and screen lighting information of the terminal (refer to, for example, Non Patent Literature 1). However, there is the problem that, in a state in which a user uses a terminal and the terminal frequently performs communication, it is not possible to predict a timing at which communication does not occur and it is not possible to perform network control such that experience quality of the user is not deteriorated.

### CITATION LIST

### Non Patent Literature

Non Patent Literature 1: Takeo Onishi, et al., A Method for Predicting Traffic Generation in Smartphones. Research Report, Mobile Computing and Pervasive System (MBL), 2016, 2016.26: 1-6.

### SUMMARY OF INVENTION

### Technical Problem

An object of the present disclosure is to enable network control to be executable that does not deteriorate experience quality of a user even in a case where the user uses a terminal.

### Solution to Problem

A communication processing device according to the present disclosure,
when detecting occurrence of network control that is different from a user controlled application,
collects user information indicating a state of a user that uses a terminal,
predicts an experience quality change of the user in a case of executing the network control using the user information obtained by the collection, and
executes the network control on the basis of experience quality of the user obtained by the prediction.

In a communication processing method according to the present disclosure,
a communication processing device,
when detecting occurrence of network control that is different from a user controlled application,
collects user information indicating a state of a user that uses a terminal,
predicts an experience quality change of the user in a case of executing the network control using the user information obtained by the collection, and
executes the network control on the basis of an experience quality change amount of the user obtained by the prediction.

Specifically, a communication processing program of the present disclosure is a program for causing a computer to implement each functional unit included in the device according to the present disclosure, and is a program for causing a computer to execute each step included in a communication method executed by the device according to the present disclosure.

### Advantageous Effects of Invention

The present disclosure enables network control to be executable that does not deteriorate experience quality of a user even in a case where the user uses a terminal.

### BRIEF DESCRIPTION OF DRAWINGS

FIG. 1 illustrates a schematic configuration diagram of the present disclosure.

FIG. 2 illustrates an example of a block configuration diagram of a system according to the present disclosure.

FIG. 3 is a flowchart illustrating an example of an operation of the system of the present disclosure.

FIG. 4 is a flowchart illustrating an example of the operation of the system of the present disclosure.

FIG. 5 illustrates an example of a flowchart through which data sets used for learning are aggregated in a learning phase in machine learning.

### DESCRIPTION OF EMBODIMENTS

Hereinafter an embodiment of the present disclosure will be described in detail with reference to the drawings. Note that the present disclosure is not limited to the embodiment described below. These examples are merely examples, and the present disclosure can be implemented in a form with various modifications and improvements based on the knowledge of those skilled in the art. Note that components having the same reference sign in the present specification and the drawings indicate the same components.

Network control that is different from a user controlled application of the present disclosure is intended for any similar control such as network processing and software update. Here, handover between different networks is taken as an example, and preconditions of target control will be described. Hereinafter in the present disclosure, there may be a case where network is referred to as NW.

A user terminal in recent years can select a plurality of cellular lines or wireless LAN lines, and the surrounding radio wave environment is connectable to any line in many cases. Therefore, the terminal can perform inter-heterogeneous NW handover for a high-quality or low-cost communication environment. In addition, the handover may be performed even in a case of not involving geographical movement. For example, in some cases, a line used by the user terminal may be selected by the terminal itself according to some algorithm, and in other cases, may be connected to an instructed line upon receiving an instruction from a connection destination control server or the like on the NW.

There is a certain time lag in a timing of performing the inter-heterogeneous NW handover. Deterioration in application experience quality in the inter-heterogeneous NW handover occurs mainly in a case where the handover is executed while a terminal and an application server are communicating with each other. For this reason, if the handover can be performed at a communication non-occurrence timing of the application within the time lag of the handover, it can be considered that the degradation in experience quality of the user can be suppressed.

In the same cellular NW handover, unless band compression from surrounding terminals is not significant, continuity of a communication protocol of an Internet Protocol (IP) layer or higher is ensured, and no problem occurs (refer to, for example, Non Patent Literature 1). However, in handover in the heterogeneous NW, when handover is performed during communication, the communication protocol (TCP, HTTP, etc.) of the IP layer or higher is affected along with a change of an IP address, and thus, some devise is required for a control timing for a user that is executing the application in the foreground.

### POINTS OF PRESENT DISCLOSURE

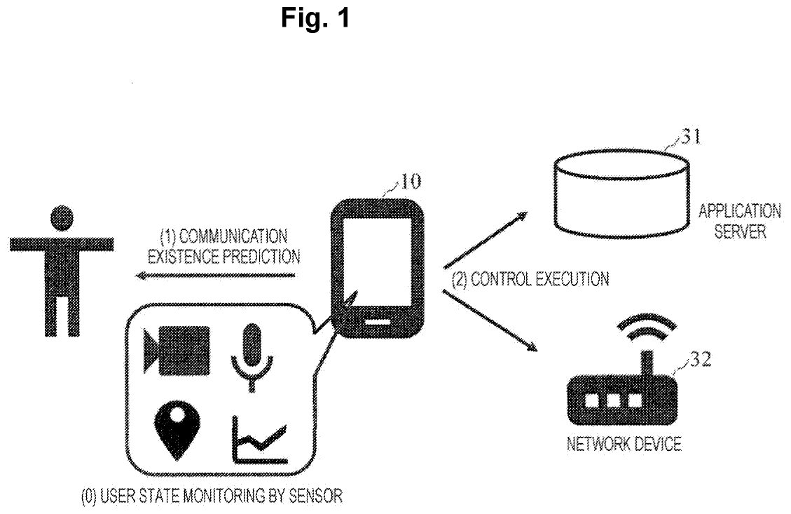

FIG. 1 illustrates a schematic configuration diagram of the present disclosure. A terminal 10 executes a user controlled application and communicates with an application server 31. On the other hand, the terminal 10 communicates with a network device 32 for network control different from the user controlled application. The terminal 10 functions as a communication processing device of the present disclosure.

The present disclosure collects user information from a sensor group included in the terminal 10, and predicts a timing at which the user does not generate communication or a timing at which the user does not pay attention to communication quality even if the communication quality deteriorates.

The terminal 10 drives a sensor such as a camera at a timing at which NW control is required, and detects whether the user and the terminal 10 are in contact with each other, whether the user exists in front of the terminal 10, whether a sight line of the user is directed, or the like. As a result, user information indicating the state of the user that uses the terminal 10 is collected. A sensor to be used and an application case of the sensor will be described later.

The present disclosure predicts traffic and experience quality change of the user by using the detected user information. For example, the present disclosure actually models existence of traffic occurrence of an application and an occurrence probability using the detected user information as a variable. Furthermore, the present disclosure uses the detected user information as a variable to model an attention degree of the user to the application at the timing and a degree of change in experience quality of the user when the NW control is performed at the timing. Then, based on the information predicted by the model, the NW control execution timing required for the terminal 10 is determined.

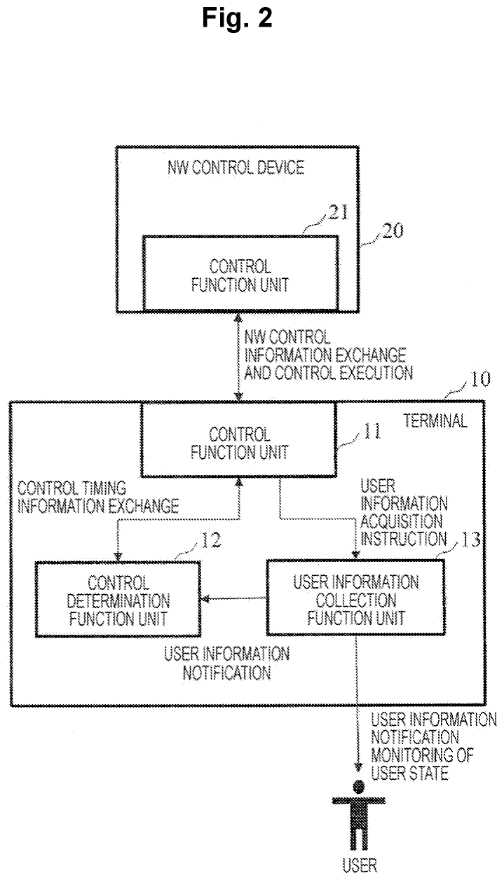

FIG. 2 illustrates an example of a block configuration diagram of a system according to the present disclosure. In the system according to the present disclosure, the terminal 10 is connected to an NW control device 20.

The terminal 10 includes:
a control function unit 11 that executes NW control such as inter-heterogeneous NW handover,
a control determination function unit 12 that determines existence of start of the NW control, and
a user information collection function unit 13 that collects user information using a sensor or the like.

Each function unit of the terminal 10 can also be implemented with a computer and a program, and the program can be either recorded on a recording medium or be provided through a network.

The control function unit 11 periodically or regularly receives control availability information from the control determination function unit 12 from a time point when the NW control is required, and executes the NW control at a timing at which it can be predicted that the user does not generate communication by the application or the user does not pay attention to the application.

The control function unit 11 drives the sensor or the like of the user information collection function unit 13 at the time when the NW control is required, to start monitoring of the user information. At this time, there may be a plurality of sensors to be used. Furthermore, communication history of the application can be referred to and used as the user information. Details will be described later.

The user information collection function unit 13 periodically or regularly transmits the user information to the control determination function unit 12. The control determination function unit 12 uses the user information from the user information collection function unit 13 as an input, to predict future communication existence of the user, its probability, and the attention degree of the user to the application. The control determination function unit 12 determines the timing of network control on the basis of the traffic and an experience quality change amount of the user obtained by the prediction. The timing of the network control based on the prediction result is output to the control function unit 11.

Furthermore, the NW control executed by the terminal 10 may be instructed and executed by an external NW device 32 on the initiative (for example, in a case where a connection destination NW is instructed from the outside). For this case, the NW control device 20 and the terminal 10 have the following functions. Note that the NW control device 20 may be a base station or a router communicating with the terminal 10 used by the user, or a server that instructs NW control.

Specifically, a control function unit 21 in the NW control device 20 notifies the terminal 10 that the NW control is required and of a maximum standby time until the NW control is executed. The terminal 10 of the user that has received the notification predicts an appropriate NW control timing by processing similar to the above, performs execution notification of the NW control to the NW control device 20 at that timing, and performs the corresponding NW control.

(Flowchart During Actual Operation)

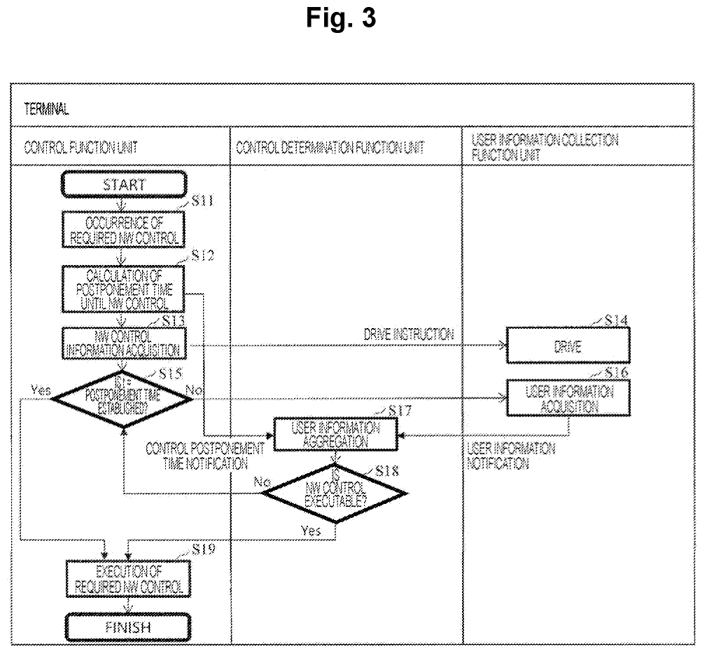

FIG. 3 is a flowchart illustrating an example of the operation of the system of the present disclosure. Here, a flowchart in a situation where the terminal 10 can execute the NW control on the initiative is illustrated.

After a required NW control is generated (S11), the control function unit 11 calculates a control postponement time (S12). In a case where, within this postponement time (S15), the user information collection function unit 13 notifies the user information (514, S16) and the control determination function unit 12 does not notify that the NW control can be executed (No in S18), the required NW control is executed upon arrival of the postponement time (S19).

Taking wireless communication as an example of calculation of the control postponement time in step S12, a conceivable method may set the control postponement time by, for example, calculating a movable distance until outside of a coverage area of the base station is reached from a threshold of a distance to an appropriately determined base station in communication, and dividing the calculated movable distance by an average moving speed of a human. In addition, these setting values may be dynamically determined on the basis of a coverage area size for each wireless standard or a moving speed of the terminal 10 or a person.

The control determination function unit 12, by using user information notified from the user information collection function unit 13 as an input, aggregates the user information (S17). For example, a communication occurrence prediction function and a user attention degree function are derived. The communication occurrence prediction function is a function that models existence of traffic occurrence or an occurrence probability with the user information as a variable. The user attention degree function is a function that models experience quality change of the user in a case where the network control is executed with the user information as a variable. These two functions may be calculated simultaneously, or only one of them may be derived and used as an index for determining whether to perform the NW control.

NW control execution propriety (S18) is determined by whether these functions fall below an appropriately determined threshold. If both functions are derived, it can be determined that the NW control is executable at a timing at which one of the functions falls below the threshold. Alternatively, a new function may be defined by a weighted sum of both functions, and whether the function is below (or above) the threshold may be used as a determination index. In addition, in a case where it is predicted that these prediction functions do not satisfy a condition under which the NW control is executable at any time within the range of the postponement time until the NW control is executed, it may be determined that the NW control is executable in a pseudo manner at a time point when the prediction is made.

At the timing at which the control determination function unit 12 determines that the NW control is executable (Yes in S18), an execution notification of the NW control to the control function unit 11 is performed, and required NW control is executed (S19).

For the required NW control (S19), for example, a network switching processing is performed. The network switching processing includes disconnection processing of a connected network, connection processing to a newly connected network, and IP address assignment. Execution of the NW switching is executable via an application programming interface (API) of an operating system (OS) of a communication terminal such as an existing smartphone, and no additional function is required as long as a method of switching processing is also defined by Ethernet (registered trademark) or an IP protocol.

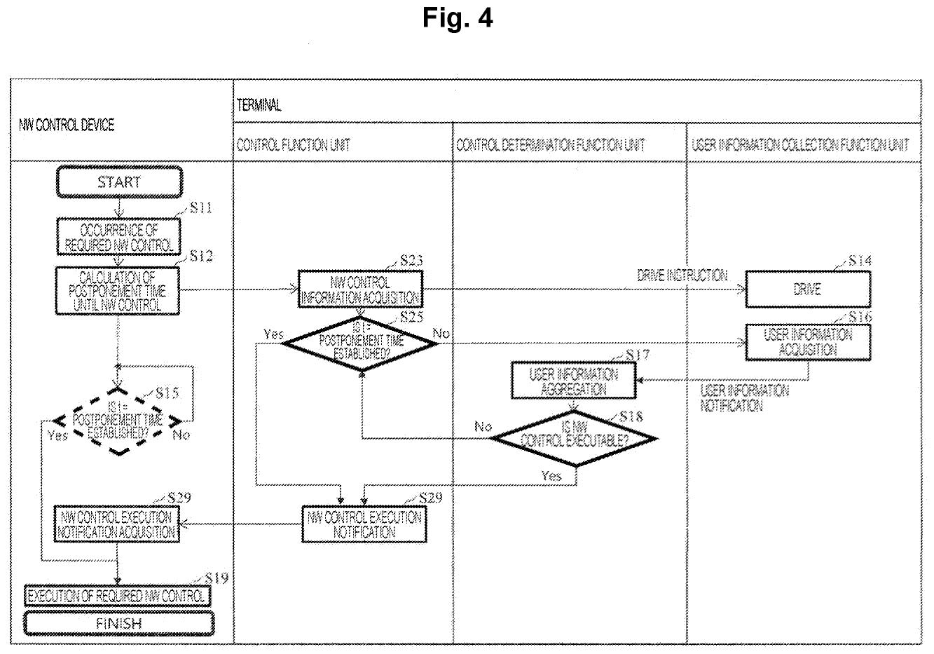

FIG. 4 is a flowchart illustrating an example of the operation of the system of the present disclosure. Here, only supplementary part of FIG. 3 will be described.

Here, a flowchart in a situation where an external apparatus executes the NW control on the initiative is illustrated.

In a case where the control determination function unit 12 cannot determine that the NW control is executable within a postponement time notified by the NW control device 20 (No in S18), the terminal 10 performs execution notification of the required NW control upon arrival of the postponement time (Yes in S25, S29). Alternatively, the NW control device 20 may store the postponement time and execute the required NW control (S19) upon arrival of the postponement time without waiting for the execution notification from the terminal 10.

For the prediction of communication existence of the terminal 10 or the prediction of a level of influence on the experience quality of the user in the aggregation of the user information (S17), prediction models for those indices are used. The prediction model at that time is a function using an input of a sensor or the like used by the user information collection function unit 13 as a variable, and such a function may be a static function set in advance. Alternatively, a function in which parameters are optimized using machine learning may be used.

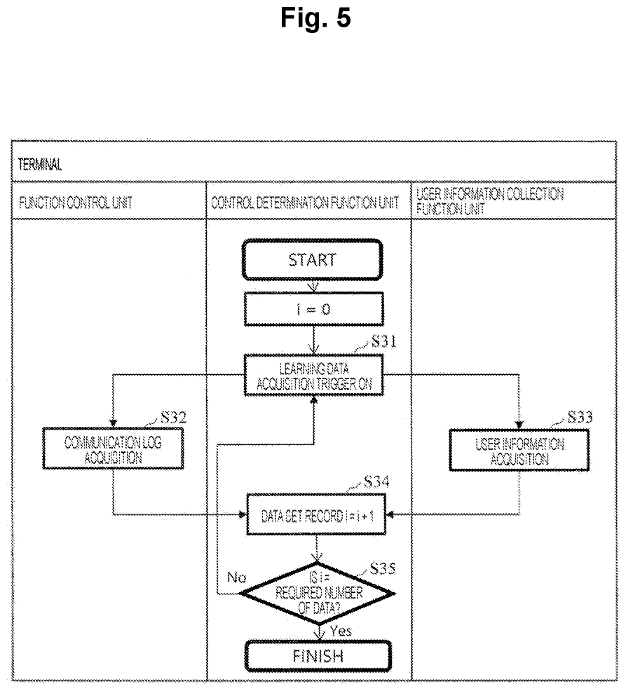

FIG. 5 illustrates an example of a flowchart through which data sets used for learning are aggregated in a learning phase in machine learning.

The control determination function unit 12 sends a notification as a trigger for acquiring learning data to the control function unit 11 and the user information collection function unit 13 at a certain time (S31).

The control function unit 11 acquires a communication log with a predetermined time width after receiving the notification, and monitors whether communication has occurred (S32). The communication occurrence information obtained here is recorded in a data set of the control determination function unit 12 as an output label for learning the communication existence (S34).

The user information collection function unit 13 acquires the user information with a predetermined time width after receiving the notification (S33). The acquired user information is sent to the control determination function unit 12, and the user information here is recorded in the data set as an input variable value in learning (S34).

The above steps are repeated until the number of data sets sufficient for learning is obtained (S35). In a case where required data sets are prepared, the data sets are used to optimize parameters of the communication occurrence prediction function or the user attention degree function by an existing machine learning method. Examples of usable machine learning methods include classification by a support vector machine and regression and classification using deep learning.

As a specific example of estimating the existence of communication occurrence and the timing at which the user does not perceive degradation of the quality degradation using the communication occurrence prediction function and the user attention degree function, a method using the following pieces of information and a combination thereof can be considered.
Example of using a traffic pattern
Example of using a camera
Example of using a motion sensor, an acceleration sensor, or a global positioning system (GPS) function
Example of using a temperature sensor
Example of using an illuminance sensor
Example of using a microphone
Example of using a screen touch history

(Example of Using Traffic Pattern)

Upstream/downstream bit rates are calculated from a communication log, and it is predicted that there is no communication at a timing at which declining of the bit rate is detected or after a certain period of time from that timing. Alternatively, communications of the TCP protocol are extracted from the communication log, and it is determined that there is no communication and the communication probability is low at the timing at which the FIN data of the TCP session is detected or after a certain period of time from that timing.

(Example of Using Camera)

The situation on a terminal screen side is monitored using an in-camera, and it is predicted that there is no communication, and the communication probability is low or the attention degree is low at the timing at which the user does not exist within an angle of view or after a certain period of time from that timing.

Alternatively, monitoring is performed similarly, and it is predicted that there is no communication, the communication probability is low, or the attention degree is low at the timing at which the user moves from a center of the screen to the outside or after a certain period of time from that timing.

Alternatively, monitoring is performed similarly, and it is predicted that there is no communication, the communication probability is low, or the attention degree is low at the timing at which the sight line of the user is not directed to a terminal side or after a certain period of time from that timing.

Alternatively, monitoring is performed similarly, and it is predicted that the communication probability is low or the attention degree is low at the timing at which the sight line of the user moves from the screen to the outside or after a certain period of time from that timing.

(Examples of Using Motion Sensor, Acceleration Sensor, or GPS Function)

When position information of the user and its derivative change, it is suggested that the user may be paying attention to movement. Therefore, a change in the position information of the user is detected using at least one of a motion sensor, an acceleration sensor, and a GPS function, and it is predicted that there is no communication, the communication probability is low, or the attention degree is low at the timing at which the position information of the user changes or after a certain period of time from that timing.

(Example of Using Temperature Sensor)

A terminal holding state of the user is monitored by a temperature sensor, and it is suggested that the user does not operate the terminal 10 when the temperature deviates from a region of a body temperature of a person. Therefore, the temperature sensor detects that the user does not operate the terminal 10, and it is predicted that there is no communication, the communication probability is low, or the attention degree is low at the timing at which the user does not operate the terminal 10 or after a certain period of time from that timing.

(Example of Using Illuminance Sensor)

In a case where an illuminance sensor changes from a dark state to a bright state, it is suggested that the user might have moved his or her face away from the screen. Therefore, it is predicted that there is no communication, the communication probability is low, or the attention degree is low at the timing at which the illuminance sensor changes from the dark state to the bright state or after a certain period of time from that timing.

(Example of Using Microphone) a Microphone Monitors Existence of Utterance of a

user, and prediction accuracy is improved in combination with other methods. For example, in a case where the utterance of the user and deviation of a sight line of the user to the outside of the screen occur at substantially the same time, there is a high possibility that the user is talking with surrounding people. Therefore, until the utterance is interrupted, it is predicted that there is no communication, the communication probability is low, or the attention degree is low.

(Example of Using Screen Touch History)

An average cycle at which the user touches the screen and a change in the cycle are taken as parameters, and the prediction accuracy is improved in combination with other methods. For example, in a scene where almost no screen touch is performed but some communication traffic is generated, it is predicted that a video application is used, and it is determined that there is no communication at a timing at which the data traffic becomes gentle (it can be predicted that the buffer is sufficiently secured).

### Advantageous Effects of Invention

As described above, the present disclosure:
drives a sensor group such as a camera of a terminal at a timing at which network control is required,
detects whether a user is using the terminal (user attention degree), and
models existence of traffic occurrence of an application, and an occurrence probability using the detected user information as a variable,
furthermore, models a change in experience quality when the network control is performed at that timing, and
determines a timing of control execution based on the information predicted by the model.

As a result, the present disclosure, even in a situation where the user terminal frequently generates the communication traffic, facilitates fine interval detection in which communication is not generated, and enables NW control at a timing at which the user does not pay attention, and thus, even if the communication traffic is generated, can suppress deterioration of experience quality of the user.

For example, in a case where background data such as a software update patch of an application has to be distributed, if main data of the application used by the user in the foreground and patch distribution data overlap with each other in terms of time, there is a risk that the experience quality of the application deteriorates since communication band allocated per user is finite. By contrast, in the present disclosure, since the distribution of the background data is executed at a timing at which the user does not pay attention, it is possible to prevent the degradation of the experience quality of the application.

In addition, when many terminals in a train simultaneously perform a handover of a cellular line base station (here referred to as an in-same NW handover), many communication resources are allocated to NW control between the terminal and the base station, and there is a possibility that the quality of an application is deteriorated due to a delay in handover processing or band compression. By contrast, in the present disclosure, since the handover processing is executed at a timing at which the user does not pay attention, it is possible to prevent the degradation of the experience quality of the application.

In addition, there is application disconnection during handover between heterogeneous NWs. Assuming a situation in which the user terminal can be connected to any of a plurality of communication lines such as a cellular line compliant with 3GPP and a wireless LAN line compliant with IEEE 802.11, when switching from an already connected line to a new line (this is referred to as handover between-heterogeneous networks), application disconnection occurs due to re-establishment processing of a TCP session by IP address change or the like (continuity is not guaranteed). During this time, the user cannot continuously use the application. By contrast, in the present disclosure, since the handover processing is executed at a timing at which the user does not pay attention, it is possible to prevent the degradation of the experience quality of the application disconnection.

### INDUSTRIAL APPLICABILITY

The present disclosure can be applied to information and communication industries.

### REFERENCE SIGNS LIST

10 Terminal
11 Control function unit
12 Control determination function unit
13 User information collection function unit
20 Network control device
21 Control function unit
31 Application server
32 Network device

1. A communication processing device,
when detecting occurrence of network control that is different from a user controlled application,
collecting user information indicating a state of a user that uses a terminal,
predicting an experience quality change of the user in a case of executing the network control using the user information obtained by the collection, and
executing the network control on the basis of an experience quality change amount of the user obtained by the prediction.

2. The communication processing device according to claim 1,
predicting traffic of an application when the network control is executed by using machine learning in which existence of traffic occurrence or an occurrence probability is modeled with user information obtained by the collection as a variable, and
executing the network control on the basis of the traffic and the experience quality change amount of the user obtained by the prediction.

3. The communication processing device according to claim 1, wherein
for predicting the experience quality change of the user, machine learning is used in which the experience quality change of the user is modeled using the user information obtained by the collection as a variable.

4. A communication processing method, in which a communication processing device,
when detecting occurrence of network control that is different from a user controlled application,
collects user information indicating a state of a user that uses a terminal,
predicts an experience quality change of the user in a case of executing the network control using the user information obtained by the collection, and
executes the network control on the basis of an experience quality change amount of the user obtained by the prediction.

5. A non-transitory computer-readable medium having computer-executable instructions that, upon execution of the instructions by a processor of a computer, cause the computer to function as the communication processing device according to claim 1.
